(19) United States
(12) Patent Application Publication
(10) Pub. No.: US 2019/0050390 A1
(43) Pub. Date: Feb. 14, 2019

(54) DATA EXTRACTION TOOL FOR PREDICTING LIGHTNING STRIKES

(71) Applicant: The Boeing Company, Chicago, IL (US)

(72) Inventors: Halasya Siva Subramania, Bangalore (IN); Ankita Mathur, Bangalore (IN); Micah Lee Goldade, Seattle, WA (US); Pattada A. Kallappa, Bangalore (IN)

(21) Appl. No.: 15/676,467

(22) Filed: Aug. 14, 2017

(51) Int. Cl. G06F 17/27

(52) U.S. Cl. CPC G06F 17/2705; G06F 17/273; G06F 17/277; G06F 17/274

(57) ABSTRACT

A system for assessing effects of lightning strikes upon a specific aircraft based on a plurality of field reports is disclosed. The system includes one or more processors and a memory coupled to the processors, the memory storing data into a database and program code that, when executed by the one or more processors, causes the system to receive as input refined data extracted from the plurality of field reports. The refined data includes text indicating a plurality of lightning strikes upon the specific aircraft and at least a portion of the text is structured into a sentence format. The system parses a unique sentence contained within the refined data to create a dependency parse graph that defines grammatical relationships between at least one word indicating a specific lightning strike upon the specific aircraft with remaining words within the unique sentence. The unique sentence indicates the specific lightning strike.

### FIELD

The disclosed system and method relates to a system for assessing effects of lightning strikes upon a specific aircraft and, more particularly, to a system for assessing lightning strikes based on field reports.

### BACKGROUND

Lightning strikes upon an aircraft may be observed in several different ways. When lightning strikes an aircraft during flight, sometimes the actual occurrence of lightning is observed by a pilot or crew member of the aircraft. Alternatively, maintenance technicians or other personnel may observe evidence of a lightning strike when servicing the aircraft. Specifically, a maintenance technician may discover features such as, for example, burn marks upon the skin of the aircraft, paint abrasions, or affected function to some of the radio or electrical systems, which indicate that lightning has struck the aircraft. The pilot or flight crew's observations, as well as any evidence of a lightning strike observed by maintenance technicians may be summarized in one or more field reports.

The reports are reviewed and analyzed by specialized personnel who are sometimes referred to as subject matter experts. The personnel are individuals with highly specialized knowledge and are typically considered to be very proficient, if not experts, at reviewing and analyzing the field reports to determine if an aircraft actually was actually struck by lightning. However, the personnel or subject matter experts tend to analyze the reports in a very subjective manner. In fact, each individual interprets and analyzes the data in the reports differently. Therefore, one individual may interpret an event in a different manner than another individual, which may lead to inconsistent analysis of aircraft. Furthermore, there is no consolidated approach for the personnel to analyze all of the data for an aircraft fleet. In addition to these drawbacks, it is often cumbersome and time consuming to collect data from multiple sources and prepare a consolidated report, which would be useful to determine the effectiveness of lightning strike protection equipment on an aircraft, to determine aircraft maintenance inspection intervals, and also when creating design changes to the aircraft to determine if adding a specific feature would encourage a lightning strike.

### SUMMARY

The disclosed system assesses the effects of lightning strikes upon a specific aircraft based on refined data extracted from field reports. The field reports summarize observations by an aircraft's pilot and crew during flight, as well maintenance records prepared by the aircraft's maintenance crew for the aircraft. Specifically, the disclosed system assesses the effects of lightning strikes based on a plurality of rules or procedures, where the rules refine data from the field reports, analyze the text contained within the field reports based on language dependency parse graphs, and determine the effects of lightning strikes upon the specific aircraft. The field reports and maintenance records are usually written using free-flowing text, and may include subjective observations and analysis created by the aircrafts' crew and maintenance technicians.

In one example, a system for assessing effects of lightning strikes upon a specific aircraft based on a plurality of field reports is disclosed. The system includes one or more processors and a memory coupled to the processors, the memory storing data into a database and program code that, when executed by the one or more processors, causes the system to receive as input refined data extracted from the plurality of field reports. The refined data includes text indicating a plurality of lightning strikes upon the specific aircraft and at least a portion of the text is structured into a sentence format. The system parses a unique sentence contained within the refined data to create a dependency parse graph that defines grammatical relationships between at least one word indicating a specific lightning strike upon the specific aircraft with remaining words within the unique sentence. The unique sentence is indicative of the specific lightning strike. The system determines a component of the specific aircraft affected by the specific lightning strike, a location of the specific lightning strike upon the specific aircraft, and at least one word indicating the specific lightning strike based on the grammatical relationships defined by the dependency parse graph.

In another example, a method for assessing effects of lightning strikes upon a specific aircraft based on a plurality of field reports is disclosed. The method comprises receiving, by a computer, refined data extracted from the plurality of field reports. The refined data includes text indicating a plurality of lightning strikes upon the specific aircraft and at least a portion of the text is structured into a sentence format. The method also includes parsing, by the computer, a unique sentence contained within the refined data to create a dependency parse graph that defines grammatical relationships between at least one word indicating a specific lightning strike upon the specific aircraft with remaining words within the unique sentence. The unique sentence is indicative of the specific lightning strike. The method further includes determining a component of the specific aircraft affected by the specific lightning strike, a location of the specific lightning strike upon the specific aircraft, and at least one word indicating the specific lightning strike based on the grammatical relationships defined by the dependency parse graph.

Other objects and advantages of the disclosed method and system will be apparent from the following description, the accompanying drawings and the appended claims.

### BRIEF DESCRIPTION OF THE DRAWINGS

FIG. 1 is an exemplary schematic block diagram of a system for analyzing one or more reports to assess the lightning strikes upon a specific aircraft;

FIG. 2 is an exemplary report that is analyzed by the system illustrated in FIG. 1;

FIG. 3 is a detailed illustration of a preprocessing block shown in FIG. 1;

FIG. 4 illustrates an exemplary language dependency parse graph created by a processing block shown in FIG. 1;

FIG. 5 illustrates a portion of another dependency parse graph where no damage has occurred to the aircraft;

FIG. 6 illustrates a portion of yet another dependency parse graph where damage to the aircraft is removed;

FIG. 7 illustrates an exemplary final report created by the system in FIG. 1, which provides a pictorial image summarizing a number of times lightning has struck various component of a specific aircraft; and

FIG. 8 is a diagrammatic view of an exemplary operating environment for the static analysis control module shown in FIG. 1.

### DETAILED DESCRIPTION

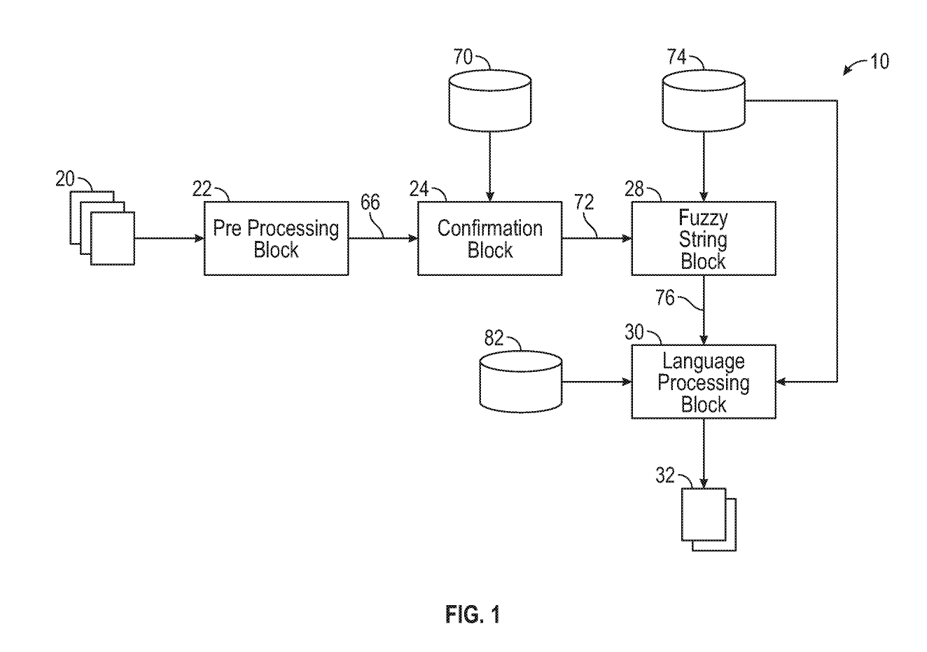

FIG. 1 is an exemplary schematic block diagram of a system 10 that receives as input one or more field reports 20. The system 10 creates refined data based on the information contained within the field reports 20, and assesses the effects of lightning strikes upon an aircraft by analyzing the refined data. The field reports 20 summarize the observations of the aircraft's pilot and crew during flight. The field reports 20 also include maintenance records prepared by maintenance technicians and other personnel when servicing the specific aircraft. The field reports 20 include issues that arise with the specific aircraft such as, for example, concerns with the aircraft's engine or navigation system. The field reports 20 also includes information indicating lightning strikes upon the aircraft. The system 10 includes a preprocessing block 22, a confirmation block 24, a fuzzy string block 28, and a language processing block 30.

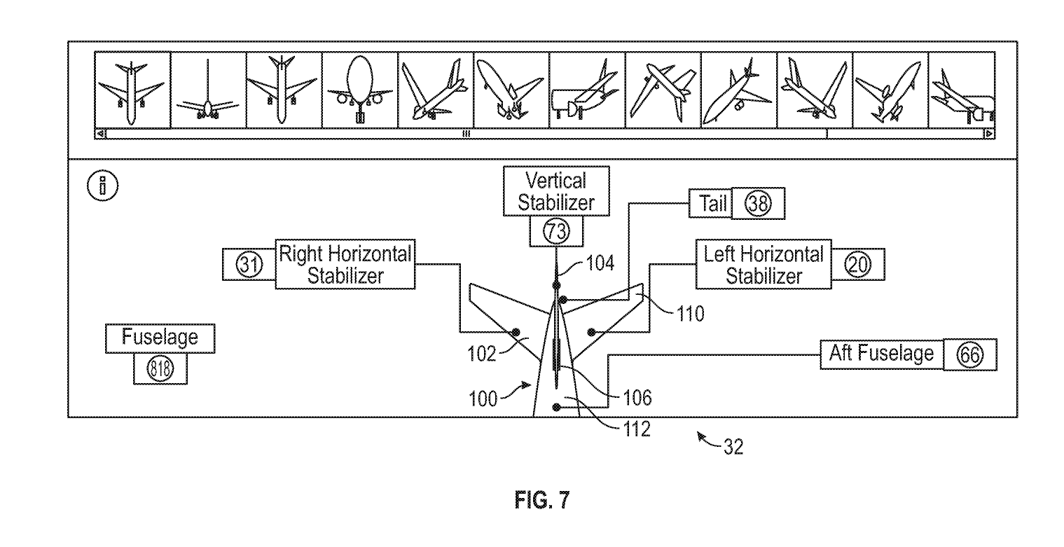

As explained below and illustrated in FIG. 7, the system 10 also disseminates the refined data as one or more final reports 32. The final reports 32 include a summarized analysis of the lightning strikes upon a specific model or category of aircraft. That is, the field reports 20 contain information relating to a specific aircraft serial number. The system 10 assesses the effect of lightning on the specific aircraft serial number, and aggregates various serial numbers of aircraft that are of the same or similar model or category into the final report 32. In the embodiment as shown in FIG. 7, an exemplary final report 32 summaries the number of times lightning has struck a specific component of the aircraft.

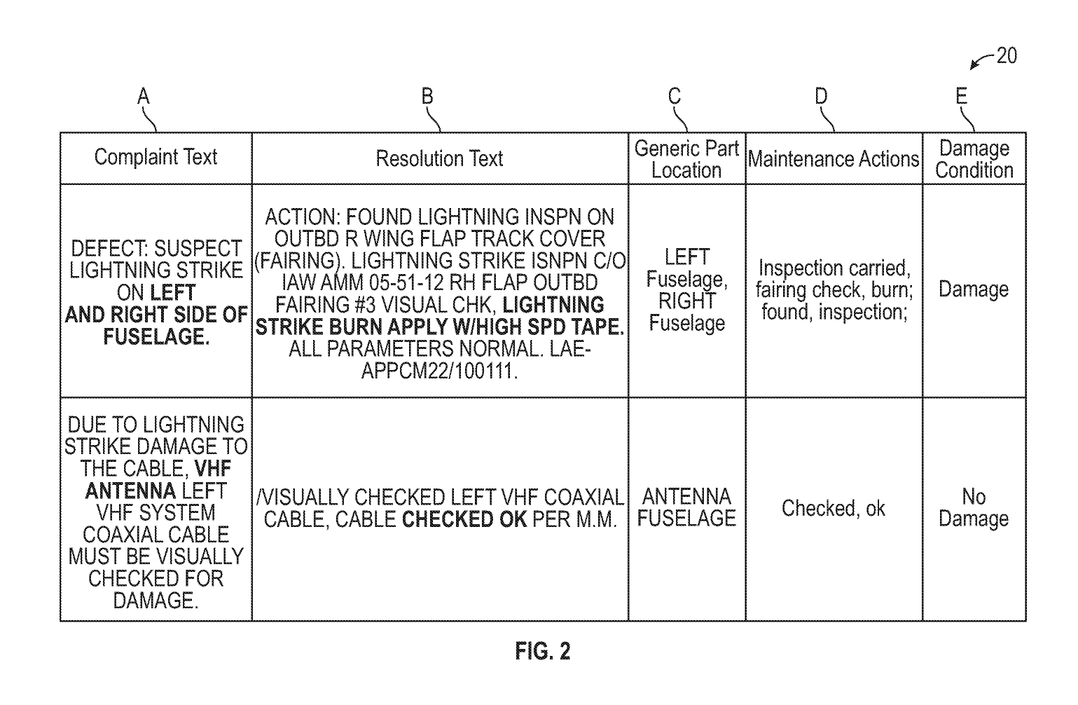

Turning now to FIG. 2, a portion of an exemplary report 20 is shown. The field report 20 includes a column A for complaint text, column B for resolution text, column C for a generic part location for an aircraft, column D for maintenance actions to the aircraft, and column E to indicate any damage to the aircraft. Although FIG. 2 illustrates a report having five rows for information relating to a lightning strike upon the aircraft, the field report 20 shown in FIG. 2 is merely exemplary in nature, and the field report 20 may include any number of different formats.

The complaint text in column A summarizes any observations from the aircraft's pilot or crew indicating a potential lightning strike. For example, the first row of column A reads “DEFECT: SUSPECT LIGHTNING STRIKE ON LEFT AND RIGHT SIDES OF FUSELAGE”, which indicate that there is a suspected lightning strike on the left and right sides of the fuselage. The resolution text in column B summarizes any observations by a maintenance technician, as well as any repairs that were made. For example, the first row of column B reads “ACTION: FOUND LIGHTNING INSPN ON OUTBD R WING FLAP TRACK COVER (FAIRING) . . . . LIGHTNING STRIKE BURN APPLY W/HIGH SPEED TAPE”, which indicates there was a burn on the right hand flap outboard fairing.

The generic part location in column C lists the components that were affected, if applicable, by the lightning strike. For example, the text in the first row reads “LEFT Fuselage, RIGHT Fuselage”. The maintenance actions in column D are a brief summary listing the actions that were taken by the maintenance technician in order to repair any damage to the aircraft created by the lightning strike. For example, the maintenance actions in column D include “Inspection carried, fairing check, burn; found, inspection”, which indicate a burn was found during inspection. Finally, the damage condition in column E indicates if there was any damage to the aircraft due to the lightning strike. In the example as shown, the second column reads “damage”, which indicates that the aircraft was affected.

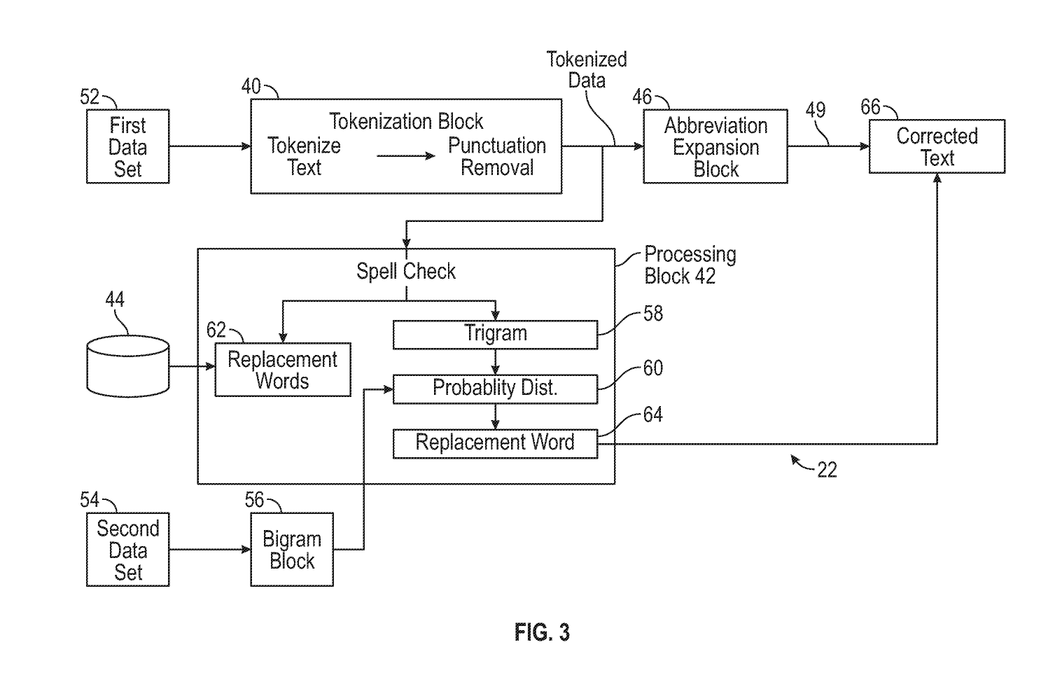

Turning back to FIG. 1, the preprocessing block 22 makes refinements to the text listed in columns A and B of the field report 20 (FIG. 2). Specifically, the preprocessing block 22 extracts the text characters listed in both columns A and B of the field report 20, and then refines the extracted text. Referring now to FIG. 3, the preprocessing block 22 includes a tokenization block 40, a processing block 42, a database 44, an abbreviation expansion block 46, and a bigram block 56. The prepressing block 22 receives as input a first data set 52 and a second data set 54. Both the first data set 52 and the second data set 54 include the data contained within the field reports 20 shown in FIG. 1.

In FIG. 3, the first data set 52 summarizes observations by an aircraft's pilot and crew during flight and maintenance records for the specific aircraft which are prepared by maintenance technicians. Specifically, the service information includes evidence that a lightning bolt struck the aircraft, which is observed by a technician or other individual during service. Some examples of evidence indicating a lightning bolt struck the aircraft include, but not limited to, burn marks upon the skin of the aircraft, paint abrasions, or affected function to some of the radio or electrical systems. As mentioned above, information indicating lightning strikes to the specific aircraft, as well as all other issues that arise during operation of the specific aircraft are also included within the first data set 52. The preprocessing block 22 filters the text of the first data set 52 and creates as output corrected text 66, which has punctuation, misspelled words, and abbreviations removed. The second data set 54 is similar to the first data set 52, but includes historical data as well. Historical data includes historical or prior maintenance records for the same model and family of aircraft. The historical data also includes reports pertaining to all known lightning strikes for the same model and family of aircraft.

The characters in the first data set 52 are tokenized by the tokenization block 40 using a regular expression. A regular expression is a string of text that describes a search pattern. Tokenization separates the text in the first data set 52 into discrete pieces such as words, keywords, phrases, and symbols, which are referred to as tokens. Information such as station numbers, manual sections such as an airplane maintenance manual or a structural repair manual, or part numbers are extracted using regular expressions. As seen in FIG. 3, the tokenization block 40 discards punctuation marks during tokenization. The tokenization block 40 outputs tokenized data. The tokenization block 40 then sends the tokenized data to the processing block 42. As explained below, the processing block 42 corrects some of the misspelled words in the tokenized text. The tokenized data is also sent to the abbreviation expansion block 46. The abbreviation expansion block 46 substitutes any tokens representing an abbreviated word with the complete form of the abbreviated word. For example, the text in row one, column B (FIG. 2) that reads “APPLY W/HIGH SPD TAPE” is expanded into “APPLY WITH HIGH SPEED TAPE”. The abbreviation expansion block 46 then creates an output of non-abbreviated text 49 based on the tokenized data.

The second data set 54 is processed by the bigram block 56 into a probability distribution 60. The probability distribution 60 is based on bigrams, which are a sequence of two adjacent words in the second data set 54. The bigram block 56 first creates the bigrams based on the second data set 54, and then determines the probability that a first word is adjacent to a second word based on the bigrams. The probability indicates a likelihood that two different words are placed next to one another in a sentence. In the event a logarithmic probability is used, a lower probability value indicates a higher probability that two words are situated adjacent to one another. For example, the term “lightning strike” has a probability value of about 1.07, while the phrase “lightening strike”, which includes an incorrect spelling for the word lightning, has a probability value of about 1.53, and the phrase “tightening strike”, which does not make any sense, has a probability value of about 1.60. The probability distribution 60 is a compilation of the bigrams and their respective probabilities.

Continuing to refer to FIG. 3, the processing block 42 receives as input the tokenized data, and scans the tokenized data for any misspelled words based on a spell check. The spell check is executed based on a context-sensitive approach, where a misspelled word is corrected based on bigrams created using historical data related to the specific model of the aircraft. Context-sensitive spelling correction involves characterizing linguistic contexts in which different words tend to occur. An example of context-sensitive spelling correction involves changing the phrase “lightening strike” to “lightning strike”, or “I would like to eat desert” with “I would like to eat dessert”. In response to the processing block 42 determining that a token contains a misspelled word during the spell check procedure, the processing block 42 generates a trigram 58 and a plurality of potential replacement words 62 that are possible substitutions for the misspelled word.

The trigram 58 includes the misspelled word as well as both words that surround the misspelled word. For example, a sentence may recite, in part, “possible lightening strike on fwd fuselage”, where the word lightning is misspelled. The trigram 58 is created based on the misspelled word. In the example as described, the trigram 58 would be “possible lightening strike”. The potential replacement words are retrieved from the database 44, which contains a lexicon of words that are commonly used in aviation. The processing block 42 compares the misspelled words with each of the potential replacement words, and selects a single replacement word 64 by selecting one of the potential replacement words having the best probability of being an appropriate replacement. For example, in the embodiment as described the processing block 42 selects the word “lightning” to replace the misspelled word “lightening”. The replacement word 64 is then combined with the tokenized data from the abbreviation expansion block 46 to create the corrected text 66.

Turning back to FIG. 1, the corrected text 66 from the preprocessing block 22 is sent to the confirmation block 24. The confirmation block 24 receives as input the corrected text 66, and retains specific observations within the input data of the field reports 20 that indicate a lighting strike. All other concerns or observations summarized within the field reports 20 are discarded. Specifically, the corrected text is searched for one or more words that indicate a lightning strike upon an aircraft. The words and phrases used to search the corrected text 66 are saved in a database 70. The database 70 is a repository of various known words and phrases that indicate lightning has struck an aircraft. Some examples of words and phrases that indicate a lightning strike include, but are not limited to, lightning strike, lightning, lightning struck, melt mark, lightning encounter, and lightning mark. In one embodiment, the various words and phrases in the repository are determined by extracting data from various reports, scholarly articles, and other documents related to lightning strikes upon aircraft.

Referring now to both FIGS. 1 and 2, in response to determining the corrected text in one or more of column A and column B contains one or more words that indicate a lightning strike, the confirmation block 24 retains the row corresponding to columns A and B. However, in response to determining the corrected text in one or more of column A and column B does not contain phrases that indicate a lightning strike, the confirmation block 24 discards the row corresponding to columns A and B. In the examples as shown in FIG. 2, both rows one and two each include the phrase “lightning strike” in Column A, and therefore are retained. The confirmation block 24 generates as output filtered data 72, which is sent to the fuzzy string block 28.

In many instances, the components of an aircraft are not spelled in the same exact form within the text boxes of the field report 20 seen in FIG. 2 when compared to the spelling presented in a manual or catalog. Accordingly, a database 74 containing a repository of various aircraft components is in communication with the fuzzy string block 28. The repository contains various permutations and common alternative spellings of various aircraft components. In one embodiment, the repository is created based on data from multiple sources that describe the various component of a specific aircraft. Some examples of sources that describe aircraft components include, but are not limited to, inventory catalogues, maintenance manuals, and schematic manuals.

The fuzzy string block 28 receives as input the filtered data 72 from the confirmation block 24, and attempts to match misspelled words commonly used in aircraft, which are included within the filtered data 72, with a component name saved in the repository of the database 74 based on fuzzy string matching. Fuzzy string matching is also referred to as approximate string matching, and involves finding strings that approximately match a specific pattern. In one non-limiting embodiment, the fuzzy string block 28 matches a specific word within the filtered data 72 with a component name stored in the repository based on Levenshtein distances. A Levenshtein distance measures the similarity between two strings, namely a source string, which is the component name saved in the repository, and a target string, which is the specific word in the filtered data 72. A distance is measured between the source string and the target string, where the number of deletions, insertions, or substitutions required to transform the source string into the target string is the distance. In one embodiment, the fuzzy string block 28 identifies a match between the source string and the target string based on a threshold distance. The threshold distance may be determined based on empirical data.

The fuzzy string block 28 is used to correct the spelling of words contained within the filtered data 72 that represent various components of the aircraft. For example, the filtered data 72 includes the misspelled word “fuselag”. The fuzzy string block 28 identifies the misspelled word “fuselag” as the fuselage of the aircraft based on fuzzy string matching. In response to matching the misspelled word contained within the filtered data 72 with a component name stored within the repository, the fuzzy string block 28 replaces the misspelled word “fuselag” with the component name saved in the repository of the database 74.

The fuzzy string block 28 creates an output 76, which is referred to as refined data 76. As explained above, the refined data 76 is based on the input data contained in the field reports 20. Specifically, the refined data 76 is determined by tokenizing the input data in the field reports 20, removing punctuation from the tokenized input data, performing a spell check on the tokenized input data, and replacing abbreviated words in the tokenized data with a compete form of the abbreviated word. The refined data 76 is further generated by retaining specific observations within the input data of the field reports 20 that indicate a lighting strike, where other concerns or observations not related to a lightning strike summarized are discarded. The refined data 76 is also generated by correcting spelling of words contained within the input data of the field reports 20 that represent various components of the aircraft. For example, as explained above the misspelled word “fuselag” is corrected to fuselage.

The language processing block 30 receives as input the refined data 76. The refined data 76 includes text indicating a plurality of lightning strikes upon the specific aircraft serial number, where at least a portion of the text is at least loosely structured into a sentence format, or even into a paragraph format. The language processing block 30 determines one or more components affected by the specific lightning strike, a location of the specific lightning strike upon the aircraft, an effect of the specific lightning strike upon the components, and the status of any actions to the affected component such as, for example, repair or replacement of the component based on the refined data 76.

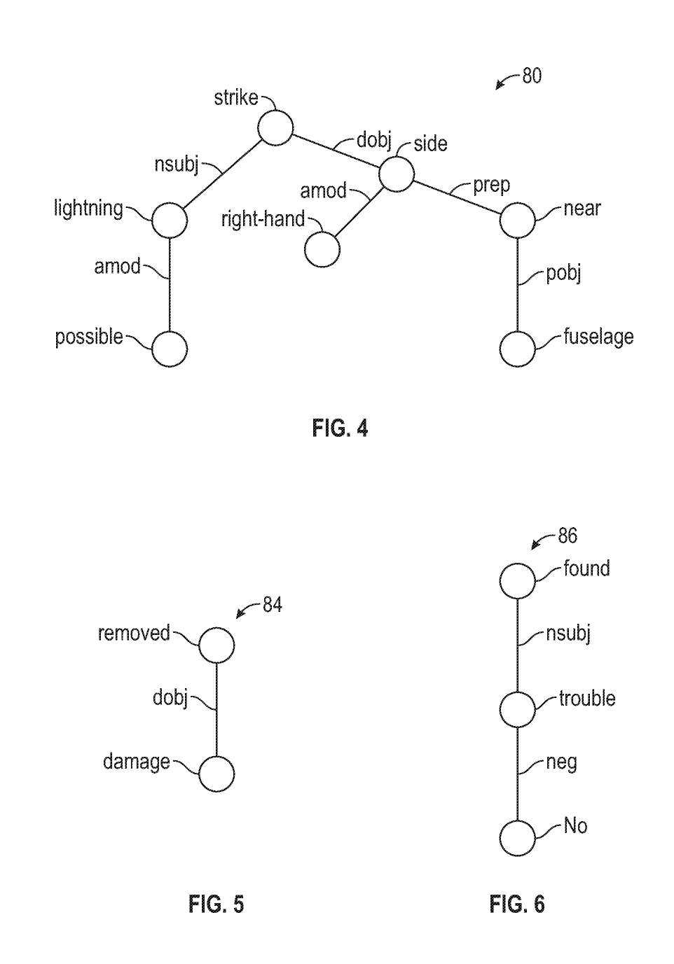

As explained in greater detail below, the language processing block 30 parses a unique sentence contained within the refined data 76 to create a language dependency parse graph 80, where the dependency parse graph 80 defines grammatical relationships between at least one word indicating a specific lightning strike upon the aircraft and the remaining portion of the words within the unique sentence. The unique sentence is indicative of the specific lightning strike. Specifically, in the exemplary embodiment as shown in FIG. 4, a structure of the unique sentence “Possible lightning strike near right-hand side fuselage” has been parsed into a dependency parse graph 80 by the language processing block 30. In particular, the dependency parse graph 80 shown in FIG. 4 is created based on a dependency parser. In the embodiment as shown, the word “strike” represents the word indicating the lightning strike, and the language processing block 30 determines the grammatical relationships between the word “strike” with the remaining words within the sentence.

A dependency parser determines the relationship between words in the unique sentence based on a word that is referred to as a head and the words that are dependent on the head. In one embodiment, the Stanford dependency parser is used, however this parser is merely exemplary, and other types of dependency parsers may be used as well. In the embodiment as shown, the word “strike” is the head of the dependency parse graph 80, and the remaining words are dependent upon the word strike. In other words, the word “strike” is considered the head, and the remaining words in the sentence depend upon the work “strike”.

There is a nominal subject relationship, which is denoted as nsubj, between the words strike and lightning. There is an adjectival modifier relationship, which is denoted as amod, between the words lightning strike and possible. There is a direct object relationship, which is denoted as dobj, between the words strike and side. There is an adjectival modifier relationship, which is denoted as amod, between the words side and right-hand. There is a prepositional modifier relationship, which is denoted as prep, between the words side and near. Finally, the word fuselage is an object of a preposition, which is near. The relationship between the words “near” and “fuselage” is denoted as pobj.

Referring now to both FIGS. 1 and 4, the language processing block 30 is in communication with the database 74, which contains the repository of various aircraft components. The language processing block 30 is also in communication with a database 82, which contains words and phrases that describe various locations about the aircraft. Some examples of words and phrases that indicate various locations of the specific aircraft such as, for example, right-hand side and left-hand side. Other examples of words that may indicate location include specific station and stringer identifiers. A station represents a theoretical vertical cross section of the aircraft, where unique station numbers are assigned along a length of the aircraft as well as from wingtip to wingtip of the aircraft. The stringers are each assigned to a unique identifier. The stringers are positioned along the length of the fuselage of the aircraft, and may be arranged in a generally circular or oval-shaped pattern with respect to one another.

The language processing block 30 analyzes and labels each word in the dependency parse graph 80 based on a particular word's relationship to a lightning strike to the aircraft, and assigns each word a category based on the analysis. Some examples of categories include, but are not limited to, a component name, a location upon the aircraft, station, stringer, section, strike indicator, damage indicator, and repair indicator. The term station, which may be referred to as STA, designates a location along a length of the aircraft. The term stringer refers to the specific stiffening member and location upon the aircraft.

In the embodiment as shown in FIG. 4, the words “possible”, “lightning” and “strike” are strike indicators. The words “side”, right-hand” and “near” indication a location upon the aircraft, and the term “fuselage” indicates the component name. The language processing block 30 then determines a component affected by the specific lightning strike upon the aircraft, a location of the specific lightning strike upon the aircraft, and at least one word indicating the specific lightning strike based on the grammatical relationships defined by the dependency parse graph. For example, the sentence “Possible lightning strike near right-hand side fuselage” results in an output tuple of “right”, “fuselage”, and “lightning strike”, where the output tuple includes three elements. Specifically, the output tuple includes three elements, the component, the location, and the lightning strike.

FIG. 5 illustrates a portion of another dependency parse graph 84, which determines an effect of the specific lightning strike of the aircraft. As seen in FIG. 5, the dependency parse graph 84 illustrates a relationship between the words “removed” and “damage”. Specifically, a direct object relationship, which is denoted as dobj, exists between the words “removed” and “damage”, which means that damage to an aircraft has been removed by repair or replacement of the component or components. In other words, the dependency parse graph 84 illustrates a portion of an exemplary sentence that indicates any effects of specific lightning strike upon the component was removed by servicing the aircraft. For example, in the embodiment as shown in FIG. 2, first row of column B indicates that a burn was removed or repaired based on applying high speed tape.

FIG. 6 illustrates an exemplary dependency parse graph 86 where the system 10 (FIG. 1) determines there was no effect to the component of the specific aircraft from the specific lightning strike based on a negation relationship defined by the dependency parse graph. As seen in FIG. 6, the dependency parse graph 86 illustrates a relationship between the words “found”, “trouble”, and “no”. A nominal subject relationship, which is denoted as nsubj, exists between the words “found” and “trouble, and a negative relationship neg exists between the words “trouble” and “no”, where the negative relationship between the subject “trouble” and issue and the word “no” have been negated.

FIG. 7 is an illustration of an exemplary final report 32, which provides a pictorial image summarizing a number of times lightning has struck various component of a model of aircraft 100 associated with the specific aircraft analyzed by the system 10 (FIG. 1). In the embodiment as shown in FIG. 7, a fuselage (not visible) of the specific model of aircraft 100 has been struck by lightning about 818 times. A right horizontal stabilizer 102 has been struck by lightning about 31 times, a vertical stabilizer 104 has been struck by lightning about 73 times, a tail 106 has been struck by lightning about 38 times, a left horizontal stabilizer 110 has been struck by lightning about 20 times, and an aft fuselage 112 has been struck by lightning about 66 times.

In addition to the pictorial image, the system 10 (FIG. 1) generates summaries summarizing the total number of times a specific model of aircraft has been struck by lightning based on a particular airline carrier. The system 10 also correlates lightning strikes to historic flight routes and historical weather behavior. By determining when and where an aircraft was struck by lightning, which is determined based on the flight routes and weather patterns, the system 10 determines an intensity of a lighting strike upon the aircraft, where the intensity of the lightning strike is measured based on amperage. In one embodiment, the system 10 identifies flight routes that pose a high risk of being struck by lightning based on the flight routes, weather patterns, and the intensity of the lightning strikes.

Referring generally to FIGS. 1-7, the disclosed computer system provides a standardized approach for extracting, analyzing, and preparing reports that summarize the effects of lightning strikes. The computer system follows a specific series of steps or rules to extract, analyze, and prepare the field reports that are based on field data. The steps or rules used to analyze the data contained within the field reports have not previously been used by skilled personnel or subject matter experts in order to determine the effects of lightning upon aircraft. Instead, the skilled personnel or subject matter experts previously analyzed the field reports subjectively. Specifically, their analysis is based on knowledge acquired by specialized training or experience, which may vary greatly between different individuals. Accordingly, the conventional approach for analyzing data to determine the effects of lightning strikes upon a specific aircraft would often result in inconsistent results. In contrast, the disclosure overcomes these shortcomings by providing a computer system that analyzes data based on a standardized, systematic methodology.

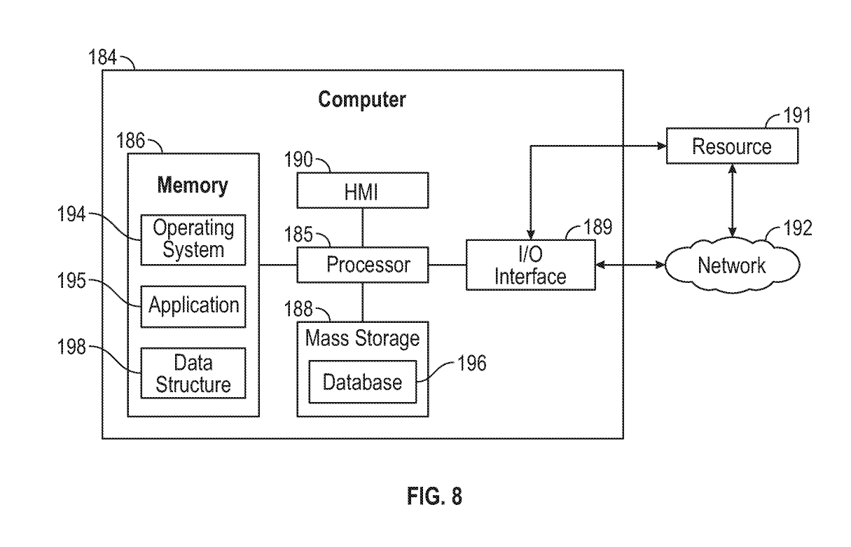

Referring now to FIG. 8, the preprocessing block 22, the confirmation block 24, the fuzzy string block 28, and the language processing block 30 in FIG. 1 are implemented on one or more computer devices or systems, such as exemplary computer system 184. The computer system 184 includes a processor 185, a memory 186, a mass storage memory device 188, an input/output (I/O) interface 189, and a Human Machine Interface (HMI) 190. The computer system 184 is operatively coupled to one or more external resources 191 via a network 92 or I/O interface 189. External resources may include, but are not limited to, servers, databases, mass storage devices, peripheral devices, cloud-based network services, or any other suitable computer resource that may be used by the computer system 184.

The processor 185 includes one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored in the memory 186. Memory 186 includes a single memory device or a plurality of memory devices including, but not limited to, read-only memory (ROM), random access memory (RAM), volatile memory, non-volatile memory, static random access memory (SRAM), dynamic random access memory (DRAM), flash memory, cache memory, or any other device capable of storing information. The mass storage memory device 188 includes data storage devices such as a hard drive, optical drive, tape drive, volatile or non-volatile solid state device, or any other device capable of storing information.

The processor 185 operates under the control of an operating system 194 that resides in memory 186. The operating system 194 manages computer resources so that computer program code embodied as one or more computer software applications, such as an application 195 residing in memory 186, has instructions executed by the processor 185. In an alternative embodiment, the processor 185 executes the application 195 directly, in which case the operating system 194 may be omitted. One or more data structures 198 may also reside in memory 186, and may be used by the processor 185, operating system 194, or application 195 to store or manipulate data.

The I/O interface 189 provides a machine interface that operatively couples the processor 185 to other devices and systems, such as the network 192 or external resource 191. The application 195 thereby works cooperatively with the network 192 or external resource 191 by communicating via the I/O interface 189 to provide the various features, functions, applications, processes, or modules comprising embodiments of the invention. The application 195 has program code that is executed by one or more external resources 191, or otherwise rely on functions or signals provided by other system or network components external to the computer system 184. Indeed, given the nearly endless hardware and software configurations possible, persons having ordinary skill in the art will understand that embodiments of the invention may include applications that are located externally to the computer system 184, distributed among multiple computers or other external resources 191, or provided by computing resources (hardware and software) that are provided as a service over the network 192, such as a cloud computing service.

The HMI 190 is operatively coupled to the processor 185 of computer system 184 in a known manner to allow a user to interact directly with the computer system 184. The HMI 190 may include video or alphanumeric displays, a touch screen, a speaker, and any other suitable audio and visual indicators capable of providing data to the user. The HMI 190 may also include input devices and controls such as an alphanumeric keyboard, a pointing device, keypads, pushbuttons, control knobs, microphones, etc., capable of accepting commands or input from the user and transmitting the entered input to the processor 185.

A database 196 resides on the mass storage memory device 188, and may be used to collect and organize data used by the various systems and modules described herein. The database 196 may include data and supporting data structures that store and organize the data. In particular, the database 196 may be arranged with any database organization or structure including, but not limited to, a relational database, a hierarchical database, a network database, or combinations thereof. A database management system in the form of a computer software application executing as instructions on the processor 185 may be used to access the information or data stored in records of the database 196 in response to a query, where a query may be dynamically determined and executed by the operating system 194, other applications 195, or one or more modules.

While the forms of apparatus and methods herein described constitute preferred examples of this invention, it is to be understood that the invention is not limited to these precise forms of apparatus and methods, and the changes may be made therein without departing from the scope of the invention.

What is claimed is:

1. A system (10) for assessing effects of lightning strikes upon a specific aircraft based on a plurality of field reports (20), the system comprising:
one or more processors (185); and
a memory (186) coupled to the one or more processors (185), the memory (186) storing data into a database (196) and program code that, when executed by the one or more processors (185), causes the system (10) to:
receive as input refined data (76) extracted from the plurality of field reports (20), wherein the refined data (76) includes text indicating a plurality of lightning strikes upon the specific aircraft and at least a portion of the text is structured into a sentence format;
parse a unique sentence contained within the refined data (76) to create a dependency parse graph (80) that defines grammatical relationships between at least one word indicating a specific lightning strike upon the specific aircraft with remaining words within the unique sentence, wherein the unique sentence is indicative of the specific lightning strike; and
determine a component of the specific aircraft affected by the specific lightning strike, a location of the specific lightning strike upon the specific aircraft, and at least one word indicating the specific lightning strike based on the grammatical relationships defined by the dependency parse graph (80).

2. The system (10) of claim 1, wherein the system (10) determines an effect of the specific lightning strike upon the component of the specific aircraft.

3. The system (10) of claim 2, wherein the system (10) determines that the effect of the specific lightning strike upon the component of the specific aircraft has been removed.

4. The system (10) of claim 1, wherein the system (10) determines that there was no effect to the component from the specific lightning strike based on a negation relationship defined by the dependency parse graph (80).

5. The system (10) of claim 1, wherein the component of the specific aircraft affected by the specific lightning strike, the location of the specific lightning strike upon the specific aircraft, and the at least one word indicating the specific lightning strike are expressed as an output tuple including three elements.

6. The system (10) of claim 1, wherein the refined data (76) is determined by tokenizing input data from the plurality of field reports (20), removing punctuation from tokenized input data, performing a spell check on the tokenized input data, and replacing abbreviated words in the tokenized input data with a compete form of an abbreviated word.

7. The system (10) of claim 6, wherein the refined data (76) is further determined by retaining specific observations within the tokenized input data that indicate a particular lighting strike and other observations unrelated to lightning strikes are discarded.

8. The system (10) of claim 6, wherein the refined data (76) is further determined by correcting a spelling of words contained within the tokenized input data that represent a specific aircraft component.

9. The system (10) of claim 6, wherein the spell check is executed based on a context-sensitive approach, and wherein a misspelled word is corrected based on bigrams created using historical data related to the specific aircraft.

10. The system (10) of claim 1, wherein the system (10) generates a final report (32) that provides a pictorial image summarizing a number of times lightning has struck various components of a model of aircraft (100) associated with the specific aircraft.

11. The system (10) of claim 1, wherein the plurality of field reports (20) summarize observations by an aircraft's pilot and crew during flight and maintenance records for the specific aircraft.

12. A method for assessing effects of lightning strikes upon a specific aircraft based on a plurality of field reports (20), the method comprising:
receiving, by a computer (184), refined data (76) extracted from the plurality of field reports (20), wherein the refined data (76) includes text indicating a plurality of lightning strikes upon the specific aircraft and at least a portion of the text is structured into a sentence format;
parsing, by the computer (184), a unique sentence contained within the refined data (76) to create a dependency parse graph (80) that defines grammatical relationships between at least one word indicating a specific lightning strike upon the specific aircraft with remaining words within the unique sentence; and
determining a component of the specific aircraft affected by the specific lightning strike, a location of the specific lightning strike upon the specific aircraft, and at least one word indicating the specific lightning strike based on the grammatical relationships defined by the dependency parse graph (80).

13. The method of claim 12, comprising determining an effect of the specific lightning strike upon the component of the specific aircraft.

14. The method of claim 13, comprising determining the effect of the specific lightning strike upon the component of the specific aircraft has been removed.

15. The method of claim 12, comprising determining that there was no effect to the component from the specific lightning strike based on a negation relationship defined by the dependency parse graph (80).

16. The method of claim 12, wherein the component of the specific aircraft affected by the specific lightning strike, the location of the specific lightning strike upon the specific aircraft, and the at least one word indicating the specific lightning strike are expressed as an output tuple including three elements.

17. The method of claim 12, comprising determining the refined data (76) by tokenizing input data from the plurality of field reports (20), removing punctuation from tokenized input data, performing a spell check on the tokenized input data, and replacing abbreviated words in the tokenized input data with a compete form of an abbreviated word.

18. The method of claim 17, further determining the refined data (76) by retaining specific observations within the tokenized input data that indicate a particular lighting strike and other observations unrelated to lightning strikes are discarded.

19. The method of claim 17, further determining the refined data (76) by correcting a spelling of words contained within the tokenized input data that represent a specific aircraft component.

20. The method of claim 17, comprising executing the spell check based on a context-sensitive approach, and wherein a misspelled word is corrected based on bigrams created using historical data related to the specific aircraft.
